(19) United States
(12) Patent Application Publication
(10) Pub. No.: US 2009/0190917 A1
(43) Pub. Date: Jul. 30, 2009

(54) Photographic equipment support

(76) Inventor: Yung-Hua George Chai, Taipei City (TW)

Correspondence Address: BIRCH STEWART KOLASCH & BIRCH, PO BOX 747, FALLS CHURCH, VA, 22040-0747, US

(21) Appl. No.: 12/010,727

(22) Filed: Jan. 29, 2008

(51) Int. Cl. G03B 17/00

(52) U.S. Cl. 396/428

(57) ABSTRACT

A photographic equipment support comprises a rotating seat for connecting with a photographic equipment; two legs provided below the rotating seat; two clamping devices provided on free ends of the legs, respectively, for fastening to a waist belt; and at least one strap to be worn around a user's back for hanging the support in front of the user's chest.

### BACKGROUND OF THE INVENTION

1. Technical Field

The present invention relates to a photographic equipment support, and more particularly to a photographic equipment support that is worn in front of a user's chest.

2. Description of Related Art

FIG. 10 illustrates a common photographic equipment support, i.e., a conventional camera tripod. In the tripod structure shown in FIG. 10, a rotating seat 50 is assembled with a guide rod 60 which extends right beneath the rotating seat 50 and has a sliding hub 80 attached thereto. Three retractable legs 70 are pivotally attached to a lower portion of the rotating seat 50 and can be stretched outwards equidistantly from one another. In addition, a supporting member 71 is pivotally connected between a central portion of each of the three legs 70 and the sliding hub 80 on the guide rod 60.

In use, the three retractable legs 70 are stretched to full lengths and pulled outwards. Held up by the supporting members 71 and the rotating seat 50, the legs 70 can now stand on a ground as three points define a plane. Before shoot, a camera (not shown) mounted on the rotating seat 50 can be adjusted via the rotating seat 50.

The basic structure of the aforementioned camera tripod, however improved, still has the following drawbacks that cannot be overcome:

1. The retractable legs generally have three or four retractable tubes. While these tubes can be designed to stretch and retract smoothly, the lengths thereof after the legs are fully stretched are fixed, as required by a necessary height to suit a standing user. As a result, the legs must have a considerable weight, which has become a main reason why many people avoid carrying a conventional tripod with them. This problem can at best be solved by using a lighter and sturdier alloy material for the legs, and yet the final products often come at a high price and are therefore not welcomed by intended users. This is another drawback of conventional tripods.

2. The three legs of a conventional tripod, when fully stretched, must take up a huge area on the ground for balance. Therefore, a conventional tripod cannot be used where it is crowded or where the ground is bumpy. In other words, conventional tripods can only be used at limited occasions. If a conventional tripod is put up by pulling the three legs thereof outwards only by a small angle, the tripod tends to lose balance and topple because of the slope it is standing on, a gust of wind, or a very slight touch, causing damage to the photographic equipment supported on the tripod. This is another drawback of conventional tripods.

3. A conventional tripod, when collapsed, becomes a weighty elongate body which cannot be carried with ease. When the tripod is put up, a user often has to bend over slightly to adjust a photographic equipment attached thereon, which can be a tiring process. Moreover, if a tripod that has been put up has to be moved for a short distance, it is as inconvenient to move the entire structure as is as to fold up the tripod first and then move it. This is the main reason why conventional tripods have not been prevalent. Now that it is so inconvenient to use a tripod outdoors as it is necessary, a consumer is faced with a dilemma that has never been effectively solved.

### SUMMARY OF THE INVENTION

The primary objective of the present invention is to provide a photographic equipment support having two relatively short legs that can be supported at a user's waist (belt) and a strap to be worn around the user's back, so that the photographic equipment support can be entirely “hung” in front of the user's chest. Thus, the support along with a photographic equipment attached thereon can be directly and more easily carried by the user, and the various drawbacks associated with conventional tripods are overcome. This constitutes the main feature of the photographic equipment support according to the present invention.

To achieve this end, the present invention provides a photographic equipment support comprising: a rotating seat for connecting with a photographic equipment; two legs pivotally attached to a side of a lower portion of the rotating seat; two clamping devices fixedly attached to free ends of the two legs, respectively, and having clamping openings facing downwards; and at least one strap having a first end portion fastened to the rotating seat and a second end portion that can be fastened to either of the legs.

In use, the two legs are fastened to a user's waist belt with the clamping openings of the respective clamping devices while the strap is wound around the user's back, so that, with the strap worn on the back and the two clamping devices fastened in place, the support is stably placed in front of the user's chest, and can move along with the user. In short, the photographic equipment support according to the present invention provides such advantages as a light structure and convenience in moving and operating.

### BRIEF DESCRIPTION OF THE DRAWINGS

The content of the present invention can be more clearly understood by viewing the following detailed description of preferred embodiments of the present invention in conjunction with the accompanying drawings, in which:

FIG. 1 is a structural drawing of a photographic equipment support according to the present invention when collapsed;

FIG. 2 is a structural drawing of the photographic equipment support according to the present invention when stretched;

FIG. 3 illustrates use of the photographic equipment support according to the present invention;

FIG. 4 is a side view of the photographic equipment support according to the present invention while in use;

FIG. 5 is a structural drawing showing a relative position between a guide rod and a sliding hub according to the present invention;

FIG. 6 is another structural drawing showing a relative position between the guide rod and the sliding hub according to the present invention;

FIG. 7 is a structural drawing of another embodiment of a clamping device according to the present invention;

FIG. 8 illustrates angles between a leg and the clamping device according to present invention;

FIG. 9 illustrates a relative position between the legs and the clamping devices of the present invention and a user's body; and

FIG. 10 is a structural drawing of a conventional tripod.

### DETAILED DESCRIPTION OF THE PREFERRED EMBODIMENT

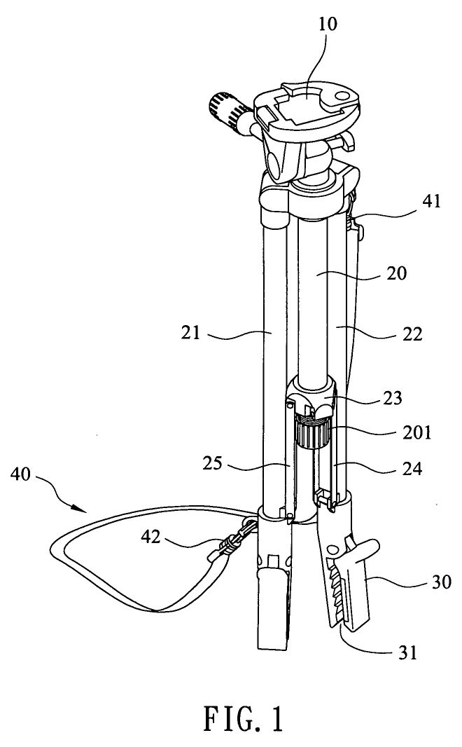

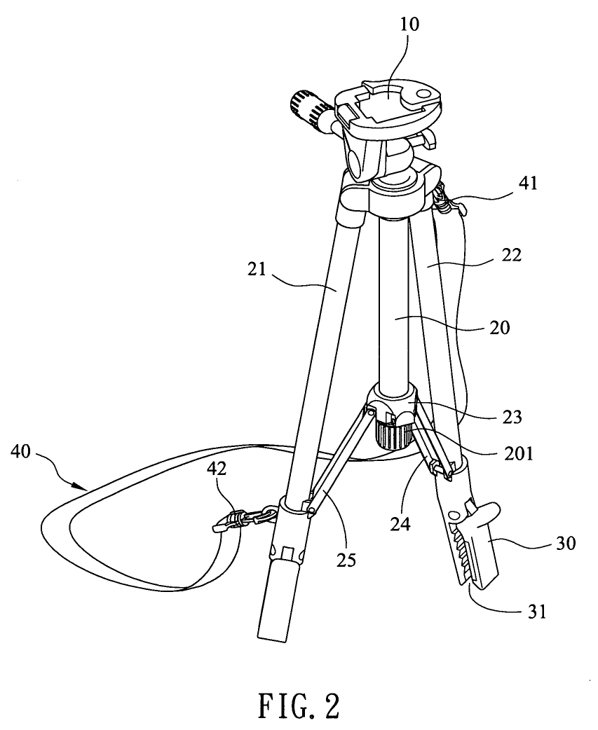

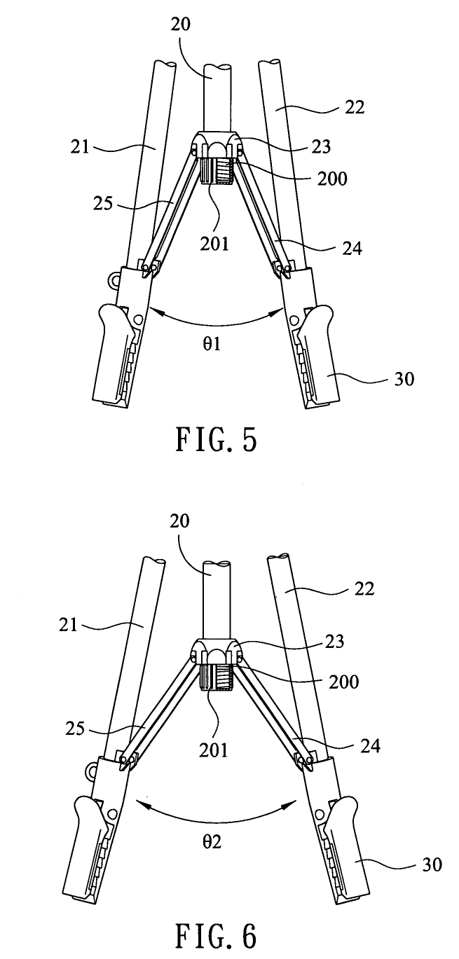

Referring to FIGS. 1 and 2, a photographic equipment support according to the present invention comprises a rotating seat 10 for connecting with a photographic equipment (not shown). A guide rode 20 is provided right beneath the rotating seat 10 and has a thread 200 at a free end thereof, with a stop nut 201 attached to the tread 200. The guide rod 20 further has a sliding hub 23 mounted on a rod body thereof above the nut 201, wherein the sliding hub 23 has an outer contour forming a conical structure, as shown in FIGS. 1 and 5. In addition, the guide rod 20 can be a hollow structure for receiving another rod (not shown) therein, so that an upward or downward motion of the sliding hub 23 is guided and therefore more stable.

Referring to FIGS. 1, 2 and 5, the photographic equipment support according to the present invention has two legs 21 and 22, which are pivotally attached to a side of a lower portion of the rotating seat 10. Each of the legs 21 and 22 has a length preferably equivalent to a distance between the waist and shoulders of an ordinary person. In addition, the legs 21 and 22 can each have a one-piece structure or a retractable two-piece structure. In either case, the total length of the structure is shorter than that of a conventional design by about a half, so that the resultant structure has a lighter weight. Moreover, a supporting member 24 is pivotally attached between the leg 22 and the sliding hub 23 on the guide rod 20, while another supporting member 25 is pivotally attached between the leg 21 and the sliding hub 23 on the guide rod 20. As a result, the sliding hub 23 can slide along the guide rod 20, thereby driving the supporting members 24 and 25 to draw the two legs 21 and 22 inwards as shown in FIG. 1, or to push the two legs 21 and 22 outwards as shown in FIG. 2.

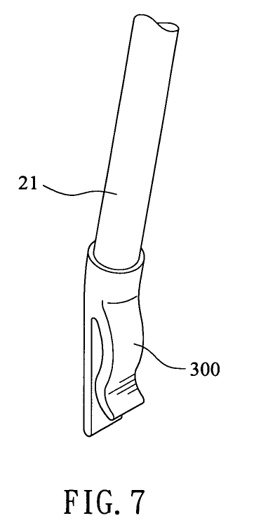

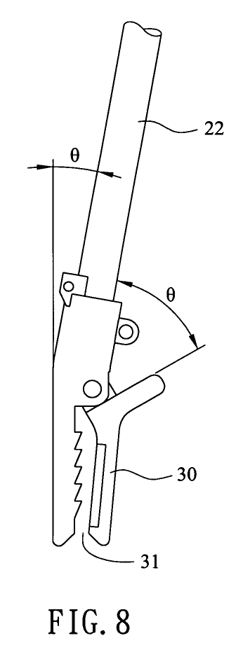

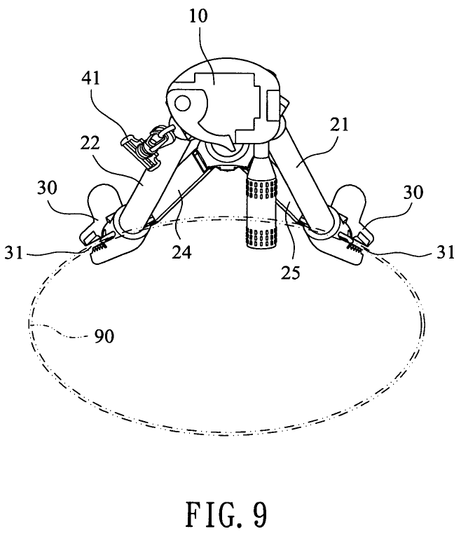

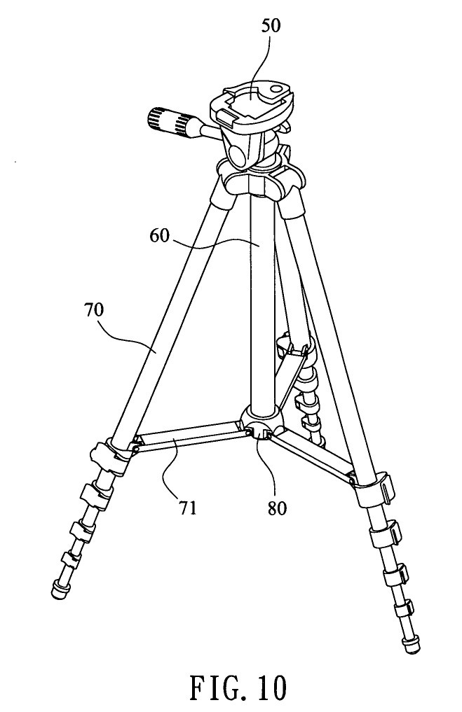

Referring to FIGS. 1 and 8, the photographic equipment support according to the present invention further comprises two clamping devices 30 fixedly attached to free ends of the two legs 21 and 22, respectively, wherein each of the clamping devices 30 has a clamping opening 31 facing downwards and deflecting from each said clamping device 30 by a small angle, so that the clamping devices 30 can be more suitably fastened to a user's waist belt without pressing against the user's stomach. As shown in FIG. 9, the clamping devices 30 are designed to be located at a front part of a waistband (as shown by the dashed circular lines in FIG. 9) on two sides, so that the two clamping devices 30 include an angle and can more fittingly match a curve of the user's waist. Therefore, the photographic equipment support of the present invention can be used more comfortably and more stably. Furthermore, the form of the clamping devices 30 can be that shown in FIGS. 1 and 2, or like a clamping device 300 shown in FIG. 7, which is a resilient clip formed with a resilient member and disposed at each of the free ends of the two legs 21 and 22. In short, the clamping devices 30 can be any of those clamping devices customarily used in our daily life and are not limited to the drawings presented herein.

Referring to FIGS. 1 and 2, the photographic equipment support of the present invention further comprises a strap 40 having a first end portion 41 fastened to the rotating seat 10 and a second end portion 42 that can be fastened to either of the two legs 21 and 22.

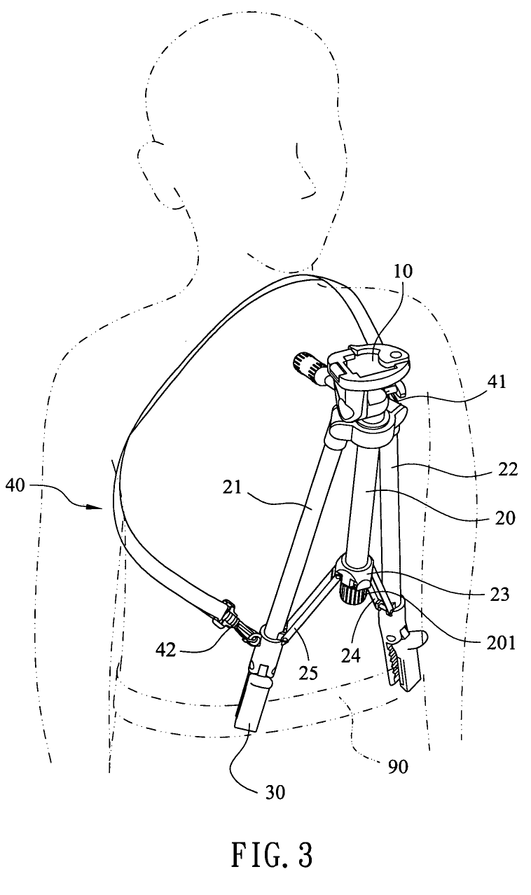

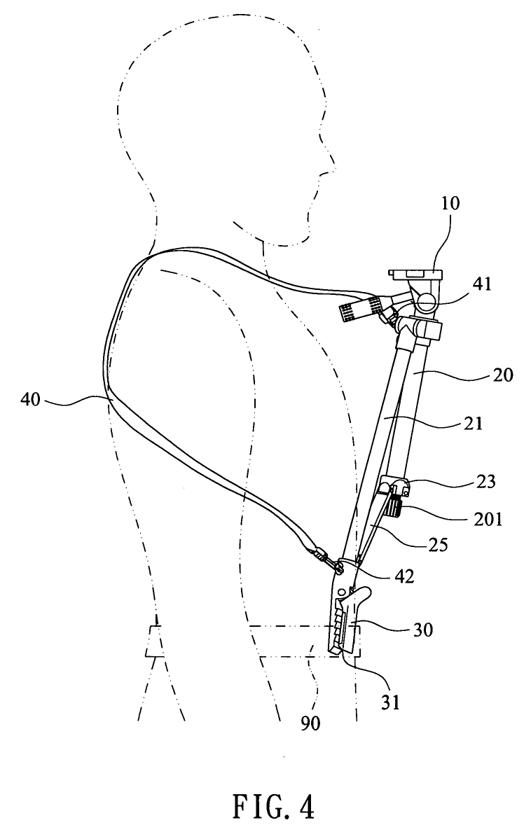

As shown in FIGS. 2, 3 and 4, the two legs 21 and 22 are fastened to a user's belt 90 with the clamping openings 31 of the respective clamping devices 30, while the strap 40 is wound around the user's back, so that the support of the present invention is disposed in front of the user's chest and can move along with the user.

An angle between the two legs 21 and 22 of the present invention can be adjusted to suit a waist width of each user. As shown in FIGS. 5 and 6, the stop nut 201 can be screwed to a higher or lower position along the thread 200 of the guide 20, so that, due to the conical outer contour of the sliding hub 23, the two legs 21 and 22 can be pushed outwards or pulled slightly inwards to form different angles θ1 and θ2, thereby providing more convenient use.

In addition, the way the strap 40 is fastened to a user is not limited to wearing it diagonally on the user's back as mentioned above. As to the basic structure of the strap 40, all those pertaining to prior art should be understood as applicable to the present invention and are therefore encompassed by the appended Claims.

The photographic equipment support according to the present invention provides the following advantages while being used:

1. The legs according to the present invention are approximately half as long as conventional structures, and the number of legs are reduced from three to two. Therefore, the legs according to the present invention have a lighter weight and can be carried easily. This is the first advantage of the present invention.

2. According to the present invention, the two legs are disposed slightly slant and fastened to a user's waist belt with the clamping devices, without having to be supported on a ground. Furthermore, the photographic equipment support according to the present invention is suspended in front of the user's chest, and therefore will neither take up a lot of space on the ground as do conventional designs having three legs which have to be pulled away from one another, nor be restrained by topographic conditions, so that the photographic equipment support can be used more conveniently. This is the second advantage of the present invention.

3. The photographic equipment support according to the present invention is suspended in front of a user's chest, so that a photographic equipment which is attached thereon and has been adjusted can be moved along with the user's body at any time, in a freer and more convenient way, without being restrained. Moreover, the photographic equipment support according to the present invention can be attached to a user's body very easily, that is, by fastening the clamping devices and the strap, which is a very simple operation. This is the third advantage of the present invention.

4. The photographic equipment support according to the present invention is designed with ergonomic considerations. Without having to bend over, a user can use the support in a standing or seated position. Moreover, when the support is stably hung in place, it needs substantially no further support by the user's hands, so that the user can use the support effortlessly and will not easily feel tired from using it. This is the fourth advantage of the present invention.

In summary, the present invention provides a well-designed photographic equipment support having the following advantages. It is lighter in weight, convenient to carry and move, easy to adjust, and little affected by topographic conditions. In addition, the photographic equipment support according to the present invention does not take up too much space or make a user fatigued easily. Besides, the photographic equipment support has a simple structure, a low manufacturing cost and potential industrial value.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A photographic equipment support, comprising:
a rotating seat, for connecting with a photographic equipment;
two legs, pivotally attached to a side of a lower portion of the rotating seat;
two clamping devices, fixedly attached to free ends of the two legs, respectively, and having clamping openings facing downwards; and
at least one strap, having a first end portion fastened to the rotating seat and a second end portion that can be fastened to either of the legs.

2. The photographic equipment support as claimed in claim 1, wherein a guide rod is provided right beneath the rotating seat, in which the guide rod has a sliding hub attached thereto, and a supporting member is pivotally attached between each of the two legs and the sliding hub.

3. The photographic equipment support as claimed in claim 1, wherein each of the two legs has a length equivalent to a distance between a user's waist and shoulders.

4. The photographic equipment support as claimed in claim 1, wherein each of the two legs has a retractable structure comprising two or more components.

5. The photographic equipment support as claimed in claim 1, wherein each of the clamping devices has a structure comprising a resilient member attached to the free end of the corresponding leg for clamping.

6. The photographic equipment support as claimed in claim 1, wherein each of the clamping devices deflects from the corresponding leg by an angle.

7. The photographic equipment support as claimed in claim 2, wherein the guide rod is provided with a thread at a free end thereof, and a stop nut is screwed on the thread.

8. The photographic equipment support as claimed in claim 2, wherein the sliding hub has an outer contour forming a conical structure.
